(19) United States
(12) Patent Application Publication
(10) Pub. No.: US 2020/0390292 A1
(43) Pub. Date: Dec. 17, 2020

(54) COMBINATION BATH TOY AND ACCESSORY HOLDER

(71) Applicant: ST&T International, Inc., Zephyr Cove, NV (US)

(72) Inventor: Michael SCOTT, Zephyr Cove, NV (US)

(21) Appl. No.: 16/437,062

(22) Filed: Jun. 11, 2019

(51) Int. Cl. A47K 3/00; A63H 23/10; A47K 1/02; A47K 1/09

(52) U.S. Cl. CPC A47K 3/004; A63H 23/10; F16B 47/00; A47K 1/09; A47K 1/02

(57) ABSTRACT

A bath accessory as a combination bath toy and accessory holder is provided. A body has an animal shape with a head and a torso, and includes: a cavity in an underside of the torso extending only partially into the torso; at least one hole in the torso, the at least one hole extending from a top of torso into the cavity; and the cavity and the at least one holes defining at least one open pathways through all of the torso to receive accessories. A base has a top support surface and at least one first protrusion extending upward from the top surface and adapted to engage the cavity when the body is lowered onto the base. At least one open pathway in combination with the top support surface of the base define at least one accessory holder.

### FIELD OF THE INVENTION

Various embodiments described herein relate generally to bath toy. More specifically, various embodiments herein relate to bath toy that supports bottles of fluid (e.g., shampoo, bath wash, etc.) or other accessories.

### BACKGROUND

Young children who take baths often like to have toys in the bath with them. They also need access to accessories such as soap, shampoo, brushes, etc. Given the shape of a bathtub, the amount of space available to support toys and accessories is quite limited.

### DRAWINGS

Various embodiments in accordance with the present disclosure will be described with reference to the drawings, in which:

FIG. 1 is an upper perspective view an embodiment of the invention.

FIG. 2 is a front view of the embodiment of FIG. 1.

FIG. 3 is a rear view of the embodiment of FIG. 1.

FIG. 4 is a left side view of the embodiment of FIG. 1.

FIG. 5 is a right side view of the embodiment of FIG. 1.

FIG. 6 is a top view of the embodiment of FIG. 1.

FIG. 7 is a bottom view of the embodiment of FIG. 1.

FIG. 8 is a lower perspective view of the embodiment of FIG. 1.

FIG. 9 is a cross section view taken from line 9-9 in FIG. 6.

FIG. 10 is a lower perspective exploded view of the embodiment of FIG. 1.

FIG. 11 is an upper perspective view of the embodiment of FIG. 1.

FIG. 12 is an upper perspective view an embodiment of FIG. 1 with an accessory.

FIG. 13 is a lower perspective view another embodiment of the invention.

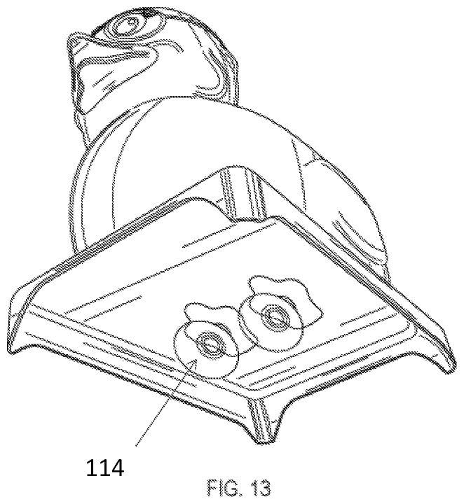

FIG. 14 is a bottom view of the toy body of the embodiment of FIG. 1.

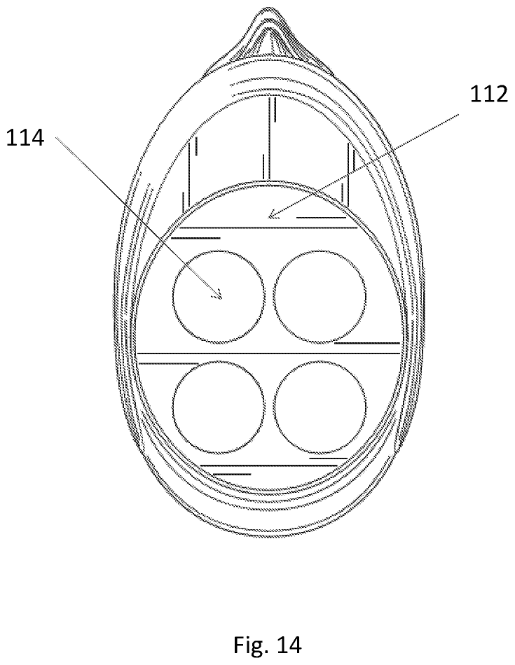

FIG. 15 is a lower perspective view of the toy body of the embodiment of FIG. 1.

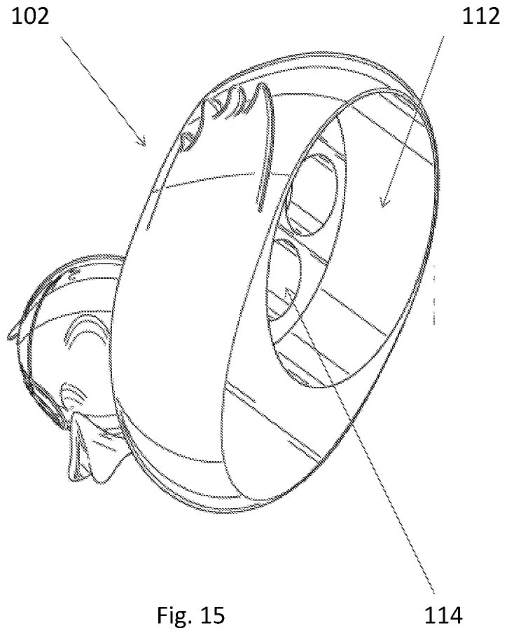

FIG. 16 is a bottom view of the toy body mounted on the support base of the embodiment of FIG. 1 with the feet attached.

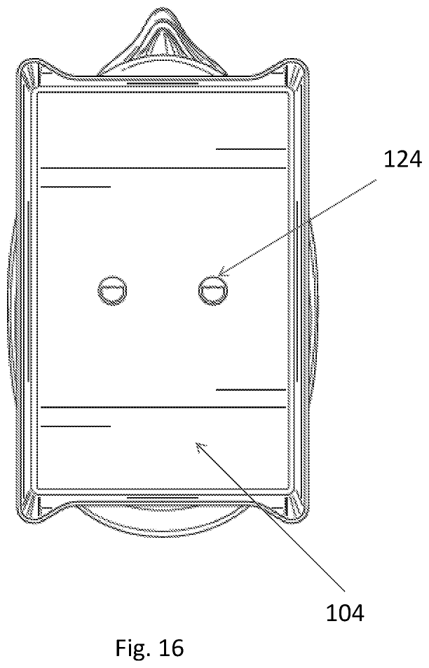

FIG. 17 is a lower perspective view of the toy body mounted on the support base of the embodiment of FIG. 1 with the feet attached.

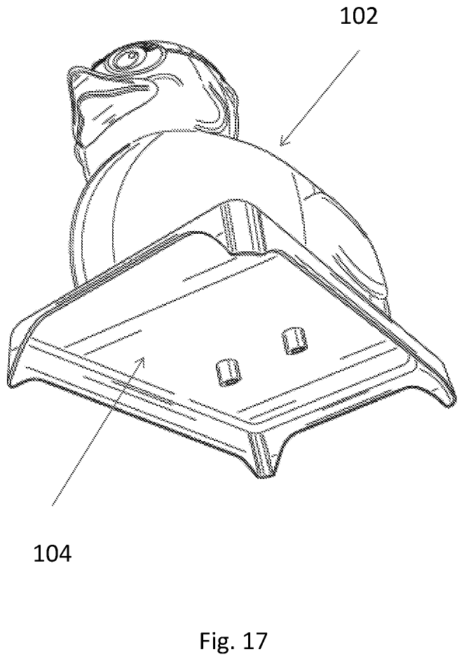

All drawings are to scale.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Several definitions that apply throughout this disclosure will now be presented. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” when utilized means “including, but not necessarily limited to”; it specifically indicates open-ended inclusion or membership in the so-described combination, group, series and the like. The term “a” means “one or more” unless the context clearly indicates a single element. The term “about” when used in connection with a numerical value means a variation consistent with the range of error in equipment used to measure the values, for which ±5% may be expected. “First,” “second,” etc., re labels to distinguish components or blocks of otherwise similar names, but does not imply any sequence or numerical limitation.

As used herein, the term “front”, “rear”, “left,” “right,” “top” and “bottom” or other terms of direction, orientation, and/or relative position are used for explanation and convenience to refer to certain features of this disclosure. However, these terms are not absolute, and should not be construed as limiting this disclosure.

Shapes as described herein are not considered absolute. As is known in the art, surfaces often have waves, protrusions, holes, recesses, etc. to provide rigidity, strength and functionality. All recitations of shape (e.g., cylindrical) herein are to be considered modified by “substantially” regardless of whether expressly stated in the disclosure or claims, and specifically accounts for variations in the art as noted above.

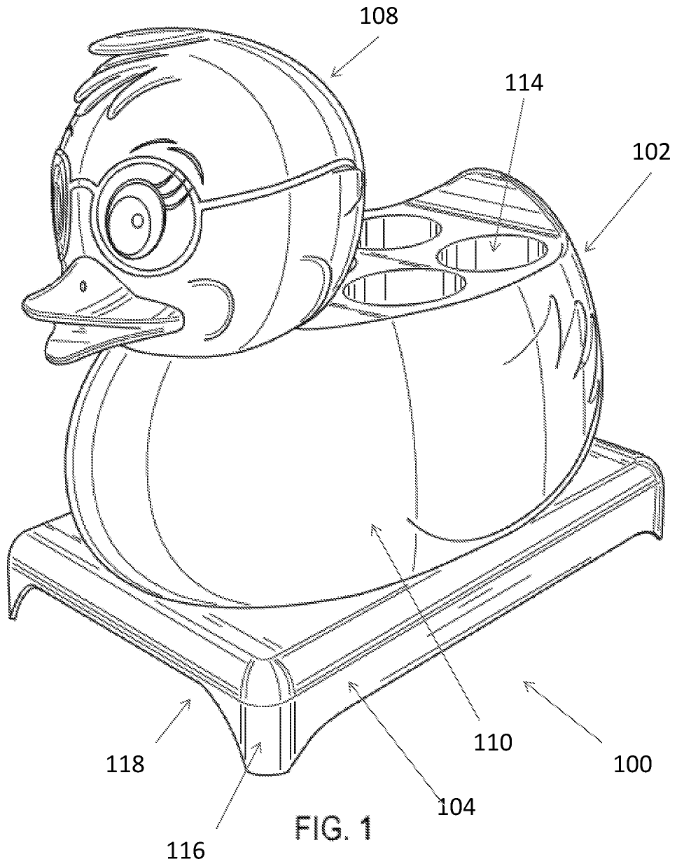

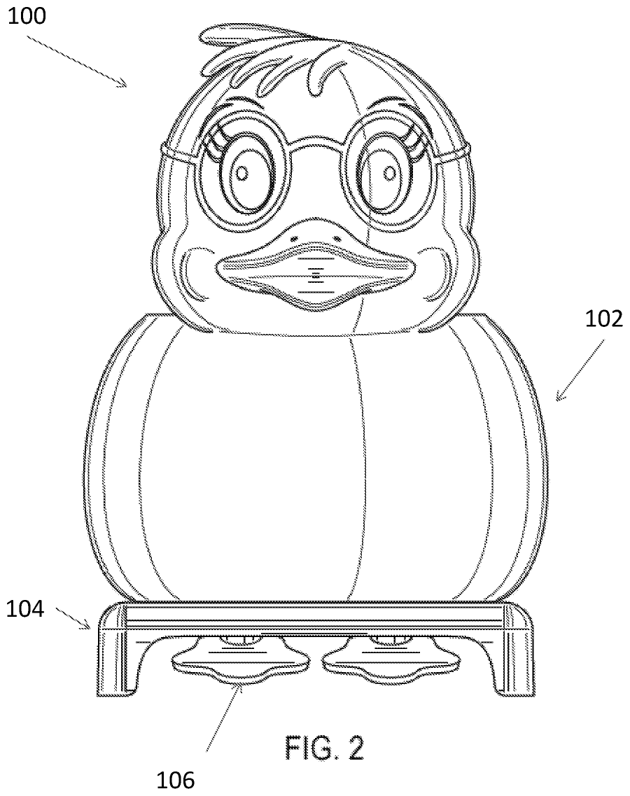

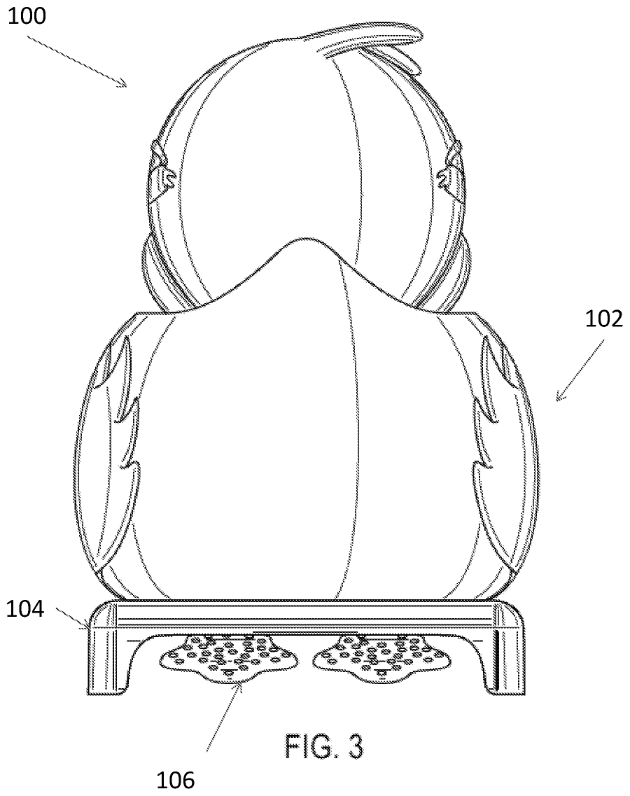

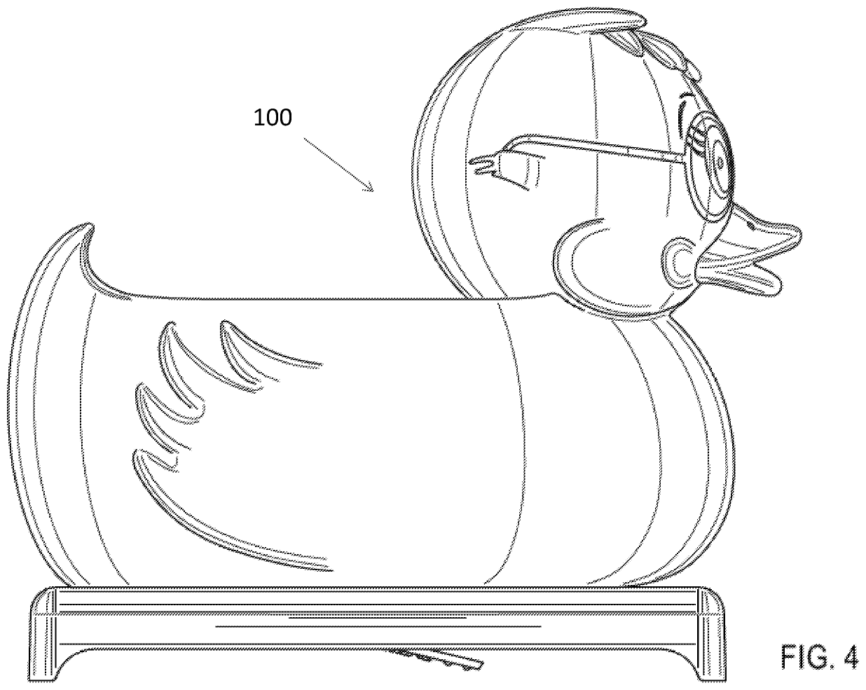

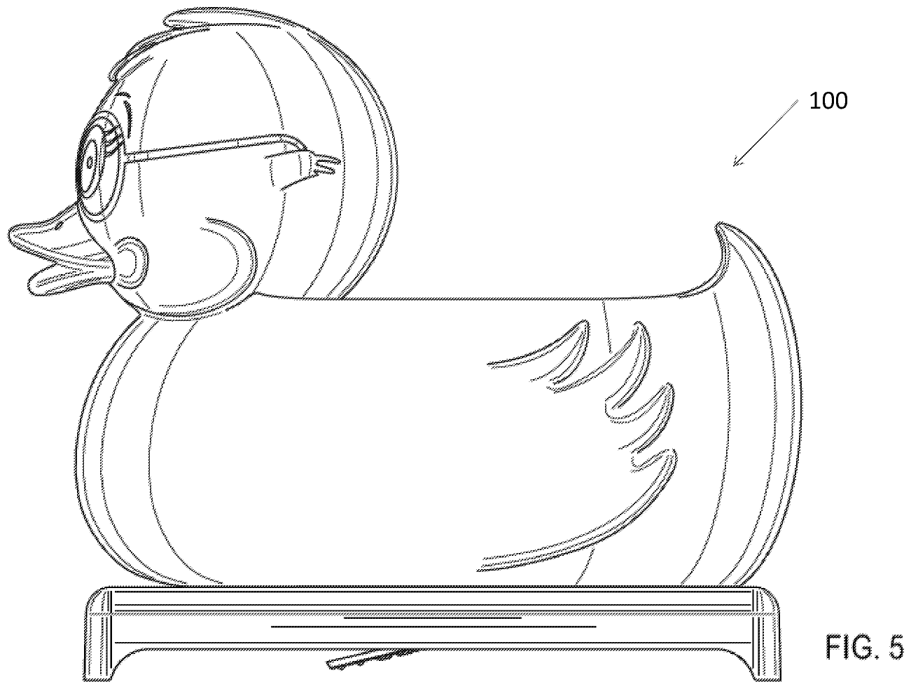

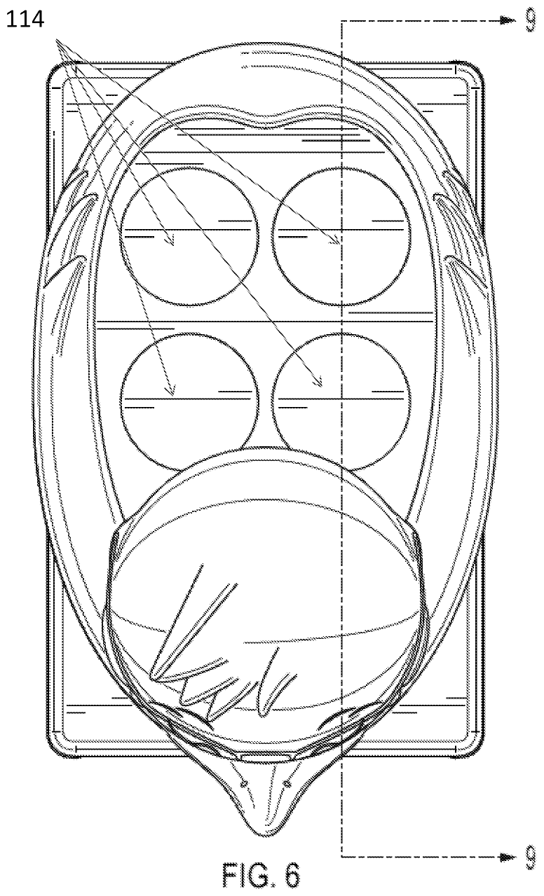

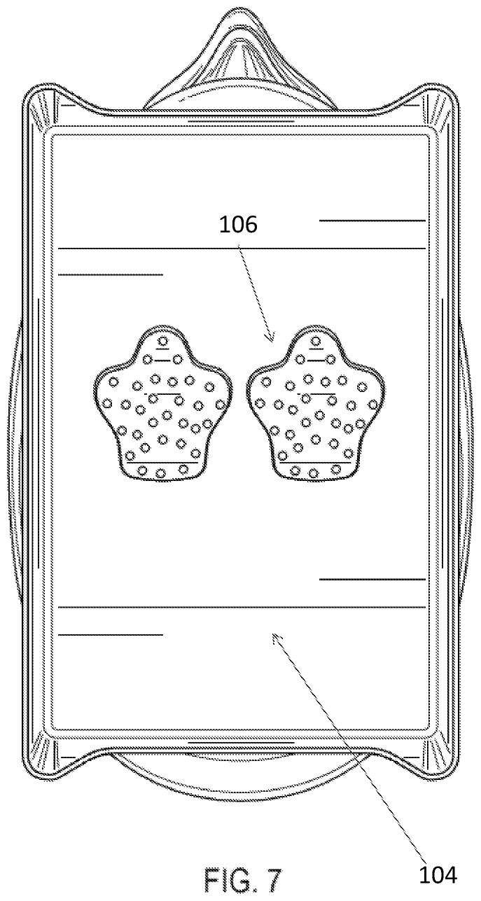

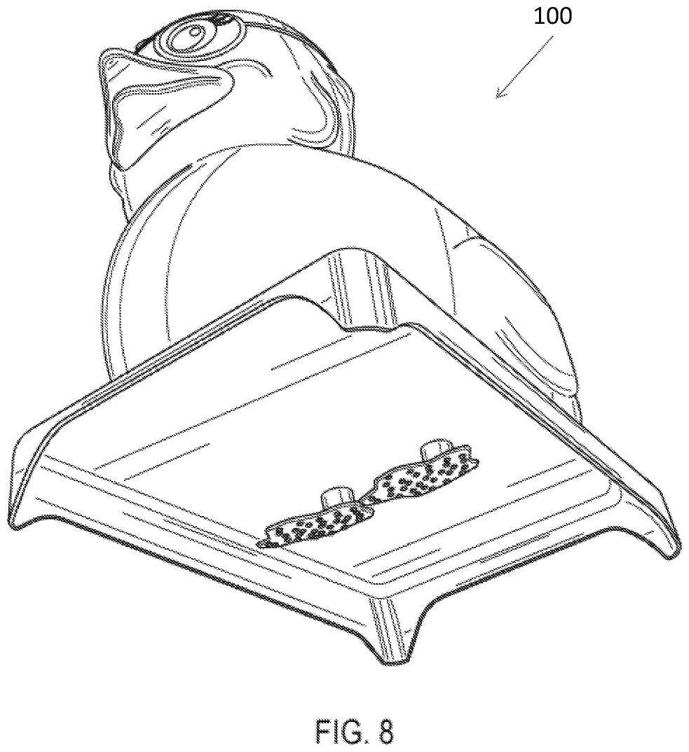

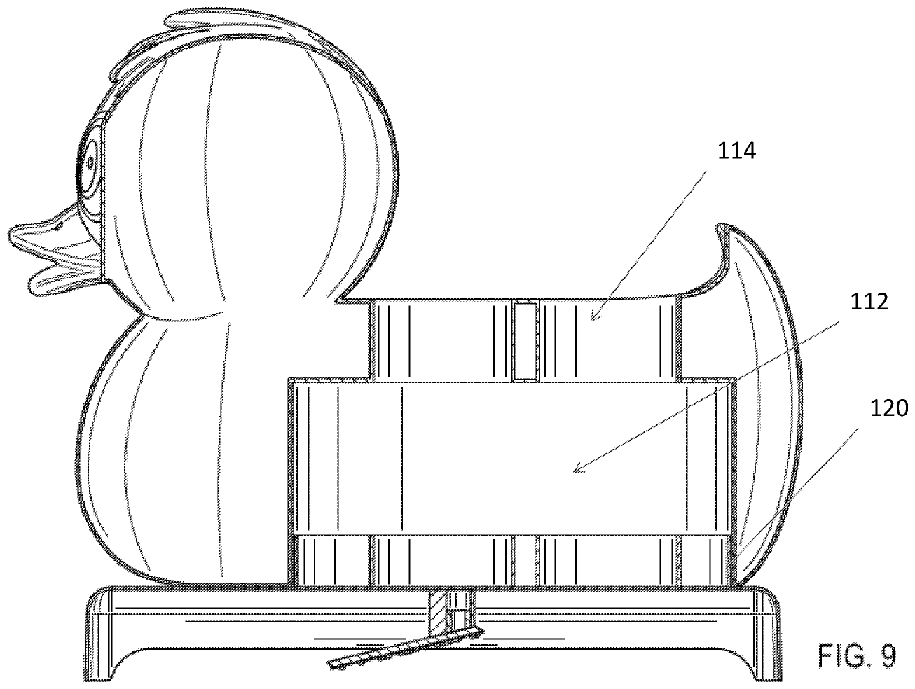

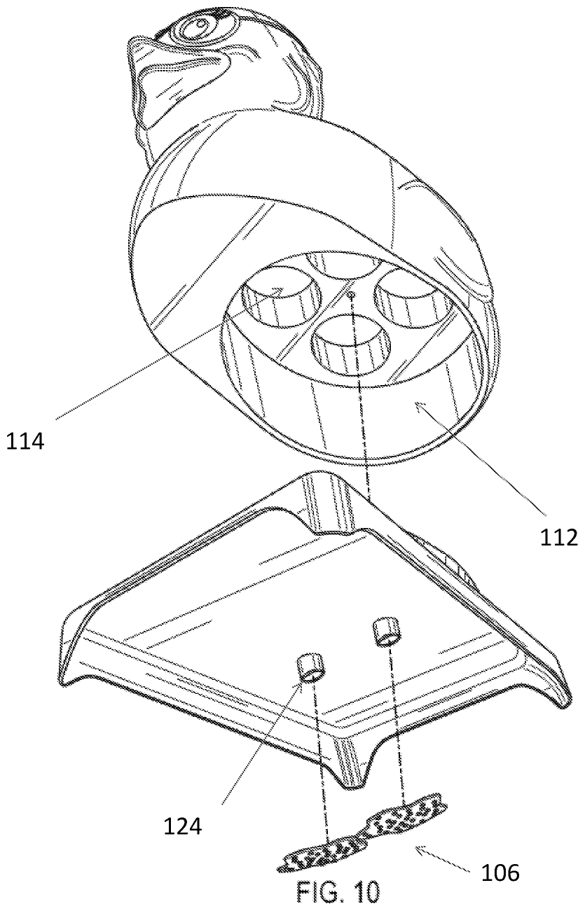

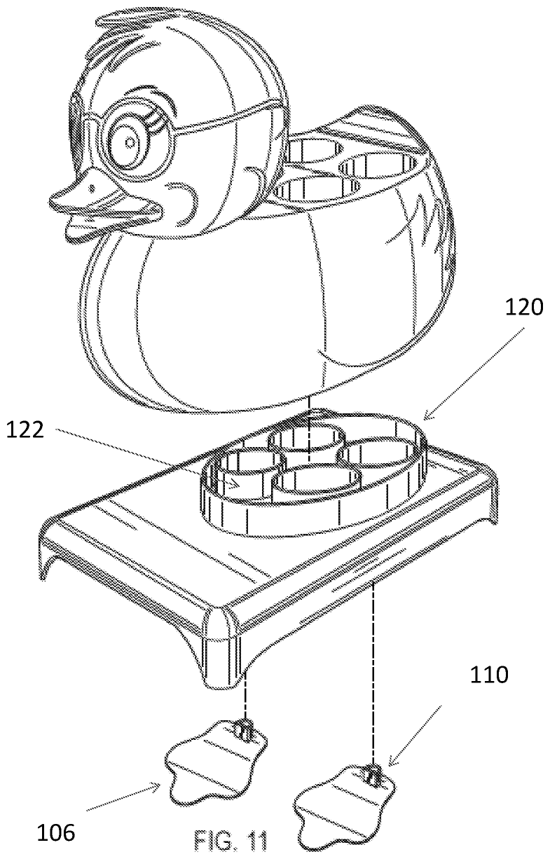

Referring now to FIGS. 1-12, a holder 100 includes a toy body 102, a support base 104, and feet 106.

Toy body 102 may be in the overall shape of an animal with a head 108 and a torso 110. A bottom surface of body 102 rests on a top support surface of base 104. Body 102 may be buoyant so body 102 floats on water, preferably with at least 80% of body 102 above the water line, and particularly with at least 90% of body 102 above the water line. This particular degree of buoyancy will allow body 102 when in water to emulate an animal floating in the water for purposes of use as a toy.

Body 102 has a cavity 112 in the bottom side of torso 110 and extends partially through torso 110. In the figures cavity 112 is shown as having an oval cross section in the horizontal plane, but the invention is not limited thereto and other shapes could be used.

Body 102 also has holes 114 that extend from the top of the torso 110 into the cavity 112; four holes are shown, although the invention is not so limited and any number of holes may be used. Each of the holes in combination with cavity 112 define an open pathway to insert an accessory, and as discussed in more detail below accessories such as bottles 150 may be inserted into holes 114 and through cavity 112; for brevity only bottles 150 are further discussed herein, although the invention is not limited to bottles and other accessories could be used. Holes 114 are shown having a common shape and size, but the invention is not limited thereto and other shapes or mixture of shapes could be used.

Support base 104 acts as a docking station for body 102. Support base 104 may have legs 116 extending downward at or near the edges to support the holder on a support surface (not shown), such as a bathtub or table. The legs define a clearance 118 there between so that water does not accumulate beneath support base 104. If feet 106 are present, they may be visible in a side external view through the clearance 118, thus complementing the overall animal shape of the body 102. As discussed in more detail below, base 104 may have suction cups or other types of attachment to secure base 104 to the support surface.

A first projection 120 shown as a uniform wall extends upward from a top surface of base 104. First projection 120 has a size and shape to match a lower portion of cavity 112 of body 102, such that body 102 can be mounted onto base 104 by aligning cavity 112 with first projection 120. Cavity 112 and first projection 120 may have sizes and shapes to collectively form a snug fit (a friction lock) to provide a measure of resistance against separation, particularly by a lateral force (e.g., a child swinging their arms in the bath tub and strikes the body 102). However, the invention is not so limited, and the fit may be loose, or simply the effect of gravity.

In the above embodiment, first projection 120 forms a contiguous wall. However, the invention is not so limited. First projection 120 may have holes, or even complete openings (such that first projection 120 may not fully define a closed area) that may prevent fluid from accumulating. First projection 120 may be a single projection (e.g., a single contiguous wall), or defined by several projections, either contiguous or spaced apart. Some or all of the first projection 120 may mate with the walls that define cavity 120. First projection 120 may include a bevel to facilitate attachment of toy body 102.

One or more second projections 122 shown as uniform walls extend upward from the top facing surface of base 104. Each second projection 122 is aligned with, and may have a size and shape to match, holes 114 of body 102, such that when body 102 is mounted onto base 104 and a bottle or other accessory is placed into a hole 114 the second projection acts as a receiving area to receive a base of the bottle 150. The walls of each of holes 114 and its aligned second projection 112 collectively define an accessory holding area.

In the above embodiment, each second projection 122 forms a contiguous wall. However, the invention is not so limited. Second projection 122 may have holes, or even complete openings (such that second projection 122 may not fully define a closed area) that may prevent fluid from accumulating. Second projection 120 may be a single projection (e.g., a single contiguous wall), or defined by several projections, either contiguous or spaced apart.

Feet 106 have an upper section 110 that attaches to a recess 124 in the underside of base 104. The attachment preferably resists removal, such as a releasable locking flange engagement, tight engagement, or other similar connection mechanism. The invention is not limited to the nature of the engagement between feet 106 and base 104.

Feet 106 may have a decorative and/or surface attachment function. The decorative aspect is literally as feet for an animal shape of the toy body as discussed above, such that the holder will have an overall appearance of an animal such as a duck. The functional aspect is to provide further support for holder 100 on the supporting surface; either or both of feet 106 may have suction cups 114 adapted to provide suction adhesions to a support surface, which in combination with the attachment to base 104 would secure holder 100 on the supporting surface. Two feet 106 mimic the two feet of the animal, although the invention is not limited to the number of feet.

In an embodiment of the invention, feet 106 are both in the shape of feet and have suction cups 114. In another embodiment, feet 106 are suction cups that do not mimic the shape of animal feet. In another embodiment, feet 106 mimic the shape of animal feet and do not have suction cups. In another embodiment, feet 106 are not provided. In another embodiment, multiple suction cups are provided on each of feet 106.

The above embodiments may be used as both a bath toy and an accessory holder.

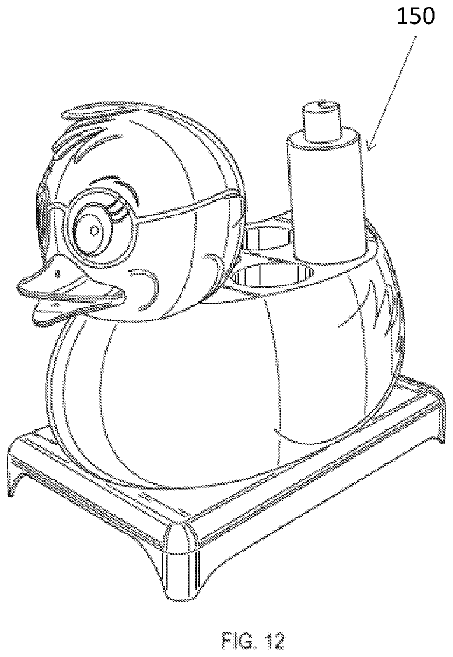

When body 102 is mounted on base 104 as shown in FIG. 12, the combination both holds the bottle(s) 150 and the body 102. The body 102 can be lifted off the base and over the bottles, whereby the base 104 will continue to act as an accessory/bottle holder and body 102 can be used as a toy. When used in a bath, the buoyancy of the body 102 in combination with the animal shape of body 102 will emulate the animal floating on water.

In embodiments where suction cups are present, the adhesion between feet 106 and the supporting surface (e.g., table, edge of bath) is preferably stronger than the resistance to separation from the friction lock between body 102 and support base 104. Thus if the bath toy 102 is lifted upward with sufficient upward force to overcome the resistance of the friction lock, bath toy 102 will separate while the support base 104 remains attached to the supporting surface.

The specification and drawings are to be regarded in an illustrative rather than a restrictive sense. It will, however, be evident that various modifications and changes may be made thereunto without departing from the broader spirit and scope of the invention as set forth in the claims.

What is claimed is:

1. A bath accessory as a combination bath toy and accessory holder, comprising:
a body having an animal shape with a head and a torso, the body comprising:
a cavity in an underside of the torso extending only partially into the torso;
at least one hole in the torso, the at least one hole extending from a top of torso into the cavity;
the cavity and the at least one holes defining at least one open pathways through all of the torso to receive accessories;
a base having a top support surface and at least one first protrusion extending upward from the top surface and adapted to engage the cavity when the body is lowered onto the base;
wherein at least one open pathway in combination with the top support surface of the base define at least one accessory holder.

2. The bath accessory of claim 1, wherein the at least one first protrusion forms a wall.

3. The bath accessory of claim 1, further comprising:
The base having a bottom surface;
at least one foot mounted on the bottom surface.

4. The bath accessory of claim 3, further comprising:
the at least one foot comprises two feet having a shape of animal feet.

5. 3, wherein the at least foot is or includes at least one suction cup adapted to provide suction adhesion between the foot and a support surface to hold the base to the support surface.

6. The bath accessory of claim 1, wherein when the body is mounted onto the base, engagement between the cavity and the at least first protrusion form a friction lock between the body and the base, the friction lock resisting removal of the body from the base.

7. The bath accessory of claim 6, wherein the friction lock between the base and the body is weaker than suction adhesion between the base and the support surface, such that sufficient upward force applied on the body will remove the body from the base without removing the base from the support surface.

8. The bath accessory of claim 1, further comprising:
an accessory fitting loosely through one of the at least one holes, extending through the cavity and being supported by the top surface of the base.

9. The bath accessory of claim 11, further comprising:
the base having at least a second protrusion extending upward from the top surface to at least partially define a lower cavity aligned with one of the at least one holes in the body.

10. The bath accessory of claim 1, wherein the body has a buoyancy such that when the body is in water the body appears as an animal floating on the water.

11. The bath accessory of claim 1, wherein the support surface has legs extending from a bottom thereof.

12. The bath accessory of claim 3, wherein the support surface has legs extending from a bottom thereof, and the at least one foot is visible from a side exterior view between the legs.

13. A bath accessory, comprising:
a body having an animal shape with a head and a torso;
the body being buoyant such that when in water the body floats on the water and simulates an animal floating on water;
a cavity in an underside of the torso extending only partially into the torso, the cavity being adapted to engage a support base;
a plurality of holes in the torso, the holes extending from the torso into the cavity such that the plurality of holes define a plurality of open pathways through all of the torso to receive accessories.

14. The bath accessory of claim 13, further comprising a base that includes:
a top support surface;
at least one first protrusion extending upward from the top surface and adapted to engage the cavity when the body is lowered onto the base, the first protrusion defining a perimeter;
a plurality of second protrusions, within the perimeter, and extending upward from the top surface and being aligned with the plurality of holes in the torso;
when the body is mounted onto the base, engagement between the cavity and the at least first protrusion form a friction lock between the body and the base, the friction lock resisting removal of the body from the base.

15. The bath accessory of claim 14, further comprising at least one suction cup connected to the base and providing suction adhesion to connect the base to a support surface.

16. The bath accessory of claim 14, wherein the friction lock between the base and the body is weaker than suction adhesion between the base and the support surface, such that sufficient upward force applied on the body will remove the body from the base without removing the base from the support surface.

17. The bath accessory of claim 14, further comprising a pair of animal shaped feet connected to and extending below the base.

18. The bath accessory of claim 17, further comprising at least one suction cup connected to the feet and providing suction adhesion to connect the base to a support surface through the feet.

19. The bath accessory of claim 18, wherein the friction lock between the base and the body is weaker than suction adhesion between the base and the support surface, such that sufficient upward force applied on the body will remove the body from the base without removing the base from the support surface.
